(19) United States
(12) Patent Application Publication
(10) Pub. No.: US 2016/0099593 A1
(43) Pub. Date: Apr. 7, 2016

(54) BATTERY CHARGE STATE EVALUATION COINCIDENT WITH CONSTANT CURRENT CHARGING

(71) Applicant: Infineon Technologies Austria AG, Villach (AT)

(72) Inventor: Cheow Guan Lim, Singapore (SG)

(21) Appl. No.: 14/506,188

(22) Filed: Oct. 3, 2014

(51) Int. Cl. H02J 7/00

(52) U.S. Cl. CPC H02J 7/0044; H02J 7/0052

(57) ABSTRACT

Disclosed techniques include delivering a substantially constant current to charge a battery including at least one electrochemical battery cell, and measuring a charging voltage of the battery while delivering the substantially constant current to the battery. The method further includes evaluating a state of charge of the battery based on the measured charging voltage and the measured test voltage, and storing, based on the evaluation of the state of charge of the battery, an indication of the state of charge of the battery in a non-transitory computer readable medium.

### TECHNICAL FIELD

This disclosure relates to battery charge state evaluations coincident with battery charging.

### BACKGROUND

Many modern electronic devices, including personal digital assistants (PDAs), laptop computers, tablet computers, e-book readers, digital cameras, digital recording devices, digital media players, video gaming devices, mobile telephone handsets, cellular or satellite radio telephones, so-called “smart phones,” other portable electronic devices, and the like may include one or more batteries that may be used to provide power to such devices. These batteries may be rechargeable batteries, which generally need to be charged periodically.

For various reasons, knowing a battery charge state of a rechargeable battery is desirable. For example, an electronic device may present an indication of the battery charge state on a user interface to indicate a user the available charge of the battery.

### SUMMARY

In general, this disclosure is directed to techniques for measuring battery charge state. The disclosed techniques facilitate battery charge state evaluation coincident with constant current charging of the battery. Constant current charging may be used for battery charging over battery charge states below relatively high charge states. In some examples, the disclosed techniques include constant current charging of the battery for a period of time sufficient to settle the bias electromotive force applied according to the charging voltage and measuring the battery voltage during the constant current charging. Based on this voltage measurement, the battery charge state may be evaluated coincident with constant current charging of the battery.

The disclosed techniques further include a controller for a portable electronic device that can deliver the constant current charging to a battery of the portable electronic device from an external power source while simultaneously directing a power from the external power source to satisfy varying power loads of other electronic components of the portable electronic device. These techniques facilitate constant current charging of the battery within the portable electronic device for a period sufficient to settle the bias electromotive force applied according to the charging voltage, which allows battery charge state evaluations coincident with constant current charging of the battery.

In one example, this disclosure is directed to a method comprising delivering a substantially constant current to charge a battery including at least one electrochemical battery cell, measuring a charging voltage of the battery while delivering the substantially constant current to the battery, evaluating a state of charge of the battery based on the measured charging voltage and the measured test voltage, and storing, based on the evaluation of the state of charge of the battery, an indication of the state of charge of the battery in a non-transitory computer readable medium.

In another example, this disclosure is directed to a portable electronic device comprising a battery including at least one electrochemical battery cell, a connection to an external power source, a controller. The controller is configured to deliver, from the connection to the external power source, a substantially constant current to charge the battery, measure a charging voltage of the battery while delivering the substantially constant current to the battery, evaluate a state of charge of the battery based on the measured charging voltage and the measured test voltage, and store, based on the evaluation of the state of charge of the battery, an indication of the state of charge of the battery in a non-transitory computer readable medium.

In a further example, this disclosure is directed to a non-transitory computer readable medium storing instructions configured to cause a programmable controller to deliver a substantially constant current to charge a battery including at least one electrochemical battery cell, measure a charging voltage of the battery while delivering the substantially constant current to the battery, evaluate a state of charge of the battery based on the measured charging voltage and the measured test voltage, and store, based on the evaluation of the state of charge of the battery, an indication of the state of charge of the battery in the non-transitory computer readable medium.

The details of one or more examples are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a two-phase buck converter that facilitates battery charge state measurements during constant current charging.

FIG. 2 is a block diagram illustrating the two-phase buck converter of FIG. 1 configured in a “fast” charging mode.

FIG. 3 is a block diagram illustrating the two-phase buck converter of FIG. 1 configured in a boost mode.

FIG. 4 is a block diagram illustrating the two-phase buck converter of FIG. 1 configured in a wireless charging mode.

FIG. 5 is a block diagram illustrating the two-phase buck converter of FIG. 1 configured in both a boost mode and a wireless charging mode.

FIG. 6 is a flowchart illustrating a method for a buck converter charger in a multiphase buck converter topology.

FIG. 7 is another flowchart illustrating another method for a buck converter charger in a multiphase buck converter topology.

FIG. 8 illustrates a portable electronic device including a battery and a controller configured to evaluate a charge state of the battery while charging the battery from an external power source.

FIG. 9 is a conceptual diagram of power distribution and voltage sensing within a portable electronic device including a battery and a controller configured to evaluate a charge state of the battery while charging the battery from an external power source.

FIG. 10 is a flowchart illustrating techniques for taking battery charge state measurement coincident with constant current charging of the battery.

FIG. 11 is a plot of voltage versus battery charge state of an example battery during charging including constant current charging below relatively high charge states at various battery temperatures.

### DETAILED DESCRIPTION

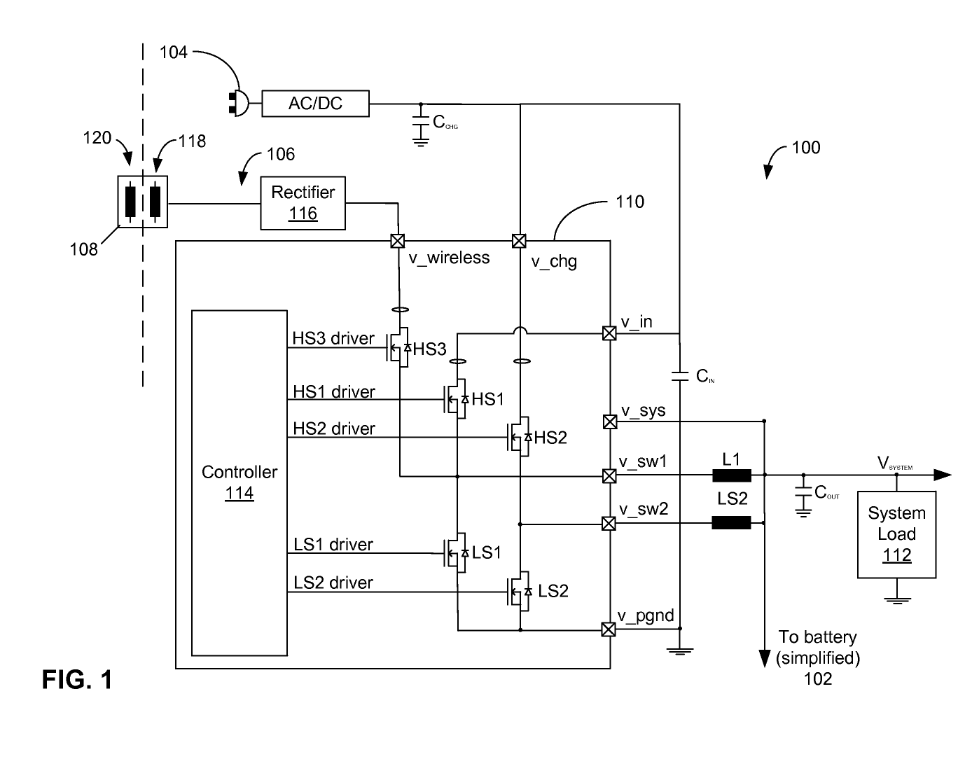

FIG. 1 is a block diagram illustrating a buck converter charger in the form of a two-phase buck converter 100. A two-phase buck converter, such as two-phase buck converter 100, may provide different charging profiles such as trickle charge, constant current, constant voltage. Some examples may provide “fast” charging, providing, for example, 5 A, 10 A, or perhaps even more. Generally, “fast” charging may be provided by any current from 5 A to 10 A or more. Some examples may have high efficiency to avoid thermal issues. Accordingly, switched mode charging may be used. Some examples may also provide “Universal Serial Bus (USB) On-The-Go,” in which the two-phase buck converter, or a portion of the two-phase buck converter may operate in boost mode to provide power from a battery (which may be charged using the buck mode of the two-phase buck converter) to the USB adapter. Additionally, some examples may provide a wireless charging mode using an additional input to provide charging power from a wireless power transformer.

The operation of a two-phase buck converter may be broken into the buck converter functionality and the boost converter functionality, as discussed below. In some examples, the converter might be implemented as a multiphase topology. The example described herein includes two phases. In some examples, the two phases may both operate as buck converters. In other examples, the two phases may both operate as boost converters. In yet other examples, one of the two phases may operate as a buck converter, while another one of the two phases operates as a boost converter. As illustrated in FIG. 1, a phase functioning as a boost converter may be provided power by a battery, output capacitor, or buck converter output.

A buck converter is a step-down DC-to-DC converter. In other words, an output voltage is less than its input voltage. It is a switched-mode power supply that, in some examples, may use multiple switches (for example, transistors and diodes), an inductor, and a capacitor to reduce the voltage of a DC supply. Linear regulators, which operate by dissipating excess power as heat may be a simpler device to reduce the voltage of a DC supply, but dissipating excess power as heat is generally inefficient. Buck converters, on the other hand, may be very efficient. Some examples may be 95% efficient or even higher. Accordingly, buck converters may be useful for converting the main voltage in a computer (for example, 12 V in a desktop, 12-24 V in a laptop) down to, for example, 0.8-1.8 V that may be needed by the processor(s) in such devices.

A boost converter is a step-up DC-to-DC converter. In other words, an output voltage is greater than its input voltage. It is a type of switched-mode power supply (SMPS). Some examples may include, for example, at least two semiconductor switches (for example, a diode and a transistor or, in some examples, two transistors) and at least one energy storage element, for example, a capacitor or inductor. Some examples may include multiple energy storage elements in combination, for example, multiple capacitors, multiple inductors, a combination of a capacitor and an inductor, or a combination of multiple capacitors and multiple inductors.

Filters, which may include one or more inductors, one or more capacitors, or some combination of one or more inductors and one or more capacitors may generally be included at an output of a converter (for example, boost converter output or buck converter output) to reduce output voltage ripple.

In some examples, circuitry may be configured to perform both a buck conversion (step-down) and a boost conversion (step-up). In other words, some circuits relate to DC-to-DC power converter circuitry that may provide both an output voltage greater than its input voltage and an output voltage less than its input voltage. In some examples, the boost converter and the buck converter may not share the same input. For example, the buck converter maybe provided with an input voltage from a rectifier while the boost converter may be provided with an input voltage from a battery charge stated by the buck converter or a voltage from the buck converter itself.

Some example circuits may be reconfigurable between, buck and boost modes, while other examples may perform both modes simultaneously. In an example that performs both modes simultaneously, some power may be stepped down to lower voltages to be used by one or more devices coupled to various outputs of the power supply, while voltages from, for example, another input, may be stepped up to one or more output voltages. In such an example, the input to the boost converter may be from a battery, from an output of a buck converter, or both. The battery and the output of the buck converter may supply power to a system load.

In some examples, circuitry implementing the buck converter may include multiphase circuitry. Multiphase circuitry may be, for example, a first buck converter circuitry in parallel with a second buck converter. In various examples, elements may be shared among the first buck converter circuitry and the second buck converter circuitry. For example, an output capacitor may be shared among the different phases and may not need to be replicated for each buck converter. Additionally, the operation of the first buck converter circuitry and the second buck converter circuitry may be synchronized, with a fixed phase-shift. Such a configuration may be referred to as a two-phase buck converter. It will be understood that additional buck converter circuitry may be added in parallel to form third, fourth, up to “n” additional phases, where “n” is any integer. The number of phases in such configurations may be limited by considerations such as the area available for such circuitry, form factor for the circuitry, or other considerations. In one example, the two-phase buck converter may include one additional phase including a third low-side switch and a third high-side switch. Additional phases may also be used including additional low-side switches and additional high-side switches.

In some examples, the multiphase buck converter may include a circuit topology that may use a series of basic buck converter circuits placed in parallel between the input and load. Each of the phases may be turned on at equally spaced intervals over the switching period. As described above, the multiphase topology may generally be used with the buck converter. In other examples, the multiphase topology may generally be used with a boost converter topology. In some examples, the phases may be reconfigurable, for example, between a boost converter mode and buck converter mode. The circuit described herein, and illustrated in FIGS. 1-5 may provide an efficient solution to combine multiple features in terms of performance, cost, thermal budgeting (charger system efficiency), and footprint in a two-phase buck converter topology.

As discussed above, several examples using a two-phase buck converter are presented, however, it will be understood that other multiphase converter topologies are possible.

In reference to two-phase buck converter 100 of FIG. 1, the example two-phase buck converter 100 may provide different charging profiles such as trickle charge, constant current charge, and constant voltage charge. Two-phase buck converter 100 may also provide for fast charging, for example, using high charge currents of up to, for example 5 A, 10 A or even higher to provide a relatively quick charge to a battery in an electronic device including a two-phase buck converter. In some examples, the ability to provide high charge currents may be related to the multiphase topology described herein. By splitting the current into different phases, the losses on the resistive components of the converter may be significantly reduced because the magnitude of the current may be divided by the number of phases while the power losses scale down by the square of the number of phases. This may impact thermal budgeting reasons mainly.

Two-phase buck converter 100 facilitates delivery of constant current charging to a battery in a portable electronic device from an external power source while simultaneously directing power from the external power source to satisfy varying power loads of other electronic components of the portable electronic device. The constant current charging of the battery within the portable electronic device allows battery charge state evaluations coincident with constant current charging of the battery in accordance with the techniques disclosed herein.

The multiphase synchronous buck converter portion of FIG. 1 illustrates two buck-mode phases, a first buck mode phase including switches high-side switch 1 (HS1) and low-side switch 1 (LS1), and a second buck mode phase including high-side switch 2 (HS2) and low-side switch 2 (LS2). The switches HS1, HS2, LS1, and LS2 may be transistors in some examples, such as bipolar junction transistors (BJTs), junction gate field-effect transistors (JFETs), metal-oxide-semiconductor field-effect transistors (MOSFETs), insulated gate bipolar transistors (IGBTs), or other types of transistors. MOSFETs are illustrated in FIGS. 1-5.

In some examples, the switches might be made from various materials, having semiconducting properties. In some examples, the switches (for example, transistors, diodes) may be certain pure elements found in group IV of the periodic table such as silicon and germanium. In some examples, the switches (for example, transistors, diodes) may be binary compounds, particularly between elements in groups III and V, such as gallium arsenide or gallium nitride, groups II and VI, groups IV and VI, and between different group IV elements, for example, silicon carbide; as well as certain ternary compounds, oxides and alloys. In some examples, the switches (for example, transistors, diodes) may be organic semiconductors, made of organic compounds. Additionally, in some examples, asynchronous Switched Mode Power Supply (SMPS) may be asynchronous, which means that one of the transistors is replaced by a diode. Thus, in some examples, switches HS1 and HS2 may be transistors and switches LS1 and LS2 may be diodes. Similarly to the transistors discussed above, these diodes might also be made from various materials, having semiconducting properties, for example, silicon, germanium, gallium arsenide, gallium nitride, silicon carbide, etc. The multiphase synchronous buck converter portion of FIG. 1 may provide for efficient fast charging, for example, greater than 5 A, up to 10 A or more.

The efficiency of two-phase buck converter 100 may be high, for example, 95% or greater, as discussed above. Using such high efficiency devices may provide for an avoidance of thermal issues, for example, overheating, which may occur if other less efficient converter topologies were used. The systems and methods described herein may accomplish this by using switched mode charging. Additionally, in some examples the two-phase buck topology, splits the current into different phases and the losses on the resistive components of the converter may be significantly reduced, as described above. As discussed above, switched mode charging is generally much more efficient than some other types of regulators.

The example two-phase buck converter 100 of FIG. 1 may provide power from a battery (not shown, near connection 102) to, for example, a Universal Serial Bus (USB) adaptor, which may be connected in place of alternating current (AC) input 104 and the AC/DC converter. In some examples, other connections for DC input power may be used, for example, v_chg may include a connection to both AC input (and the AC/DC converter) as well as the USB adaptor. In some examples, this may be referred to as “USB On-The-Go.” In some examples, two-phase buck converter 100 may provide, for example, a maximum of 7.5 W or more when operating in boost mode and providing battery power to the USB adaptor or other connector. This power may be provided at a voltage greater than the battery voltage because circuitry within two-phase buck converter 100 may increase the voltage from the battery to the output connector (for example, USB adaptor). In an example, the boost mode may reuse one of the buck mode phases, for example, HS1/LS1 or HS2/LS2 and configure one of the buck mode phases as a boost converter. For example, in the circuitry illustrated in FIG. 1, HS2 may be coupled to a USB adaptor.

Some examples may include circuitry for wireless charging 106. The circuitry for wireless charging 106 may include a transformer 108 connected to a rectifier 116 to provide charging power wirelessly to the two-phase buck converter 100. While transformer 108 illustrates both a first coil 118 and a second coil 120 together connected to two-phase buck converter 100, generally, transformer 108 may include the first coil 118 contained within two-phase buck converter 100 and the second coil 120 external to two-phase buck converter 100. These coils 118 and 120 are what generally provide for power transfer from, for example, an electrical outlet, and two-phase buck converter 100, which may be within an electronic device. In some examples, coil 118 may be part of a wireless power receiver of two-phase buck converter 100, which may be embedded in an electronic device (not shown). Coil 120 may be external to two-phase buck converter 100 and external to the electronic device. Coil 120 may be embedded in a charging pad (not shown) that the electronic device may be placed on for charging. When the electronic device with two-phase buck converter 100 embedded in it is placed on the charging pad the first coil 118 within the two-phase buck converter and the electronic device may be in close proximity to the second coil 120. Accordingly, the first coil 118 and the second coil 120 may form a transformer 108. Energy may flow from an energy source, for example, an electrical power outlet, through a wire to second coil 120. Energy may then be transferred to first coil 118 wirelessly. (Each coil 118, 120 may contain many wire windings, but no wired connection is needed between the coils 118 and 120.) The dotted line between first coil 118 and second coil 120 illustrates the lack of a wired connection between the coils 118 and 120 and to demarcate that first coil 118 may be within two-phase buck converter 100 and second coil 120 may be outside of two-phase buck converter 100. Generally, when the application indicates that two-phase buck converter 100 may be within an electronic device, this may or may not include one of the coils that may form transformer 108.

Some examples may further include an alternative charging switch, high-side switch 3 (HS3) in the two-phase buck converter, the alternative charging switch coupled to the first phase between the first high-side switch and the first low-side switch, wherein the controller is further configured to control the alternative charging switch to enable and disable an alternative charging source. Accordingly, some examples may include a coil (for example, part of transformer 108) and a rectifier 116 coupled to an alternative charging switch and configured to provide power from the coil, through rectifier 116 to the alternative charging switch HS3. In some examples, alternative charging switch HS3 may be coupled to a linear regulator.

In the illustrated example, wireless charging may be provided by reusing low side switch LS1 illustrated in FIG. 1. Generally, high-side switch HS1 is not used in this configuration. Accordingly, this phase may be re-used instead of adding a third phase for the wireless charging. One additional HS switch, for example, HS3, may provide an additional power connection to one of the buck mode phases, for example, the first phase, HS1/LS1. (In the illustrated example, this may save one LS. In other words, an additional LS switch is not used for the wireless charging feature.) In the illustrated example of FIG. 1, when an alternative charging or wireless charging is used, the alternative charging switch or wireless charging switch, for example, HS3, is generally switching in this mode When wireless charging is not being used, switch HS3 is generally off. It will also be understood that other power sources may be used in conjunction with switch HS3. In some examples, HS1 and HS2 may be connected to a pin at the top of the device top.

The circuitry for wireless charging 106 may, in some examples, provide less power than power provided through a USB adaptor when the USB adaptor is being used to provide power. The connections in the USB adaptor or other adaptor may provide power to two-phase buck converter 100 for, for example, buck converter. As discussed above, a USB adaptor may be used to power devices external to two-phase converter 100.

The operation of the two-phase buck converter is described in more detail by breaking the discussion into two different modes of operation, (1) buck and (2) boost. Generally, the basic operation of a buck converter controls the current through an inductor by using two switches (for example, transistors). In an idealized buck converter, which is discussed herein to generally describe the basic operation of a buck converter, all the components may be considered to be ideal. For example, switches may be considered to have zero voltage drop when on and zero current flow when off and the inductor has zero series resistance. Further, in an idealized buck converter it may be assumed that the input and output voltages do not change over the course of a cycle.

Generally, the current through an inductor does not change instantaneously. In a buck converter, beginning with a switch (HS1 or HS2) open, the current flowing from v_chg through the switch (HS1 or HS2) is 0. In other words, since the switch (HS1 or HS2) is open, no charging current flows through it.

When the switch (HS1 or HS2) is first closed, the current will begin to increase through inductor L1 when HS1 is closed and inductor L2 when HS2 is closed. At this time, if HS1 is open switch LS1 may be opened, and if HS2 is open switch LS2 may be opened. Since current through an inductor (L1 and L2) cannot increase instantly, the voltage across the inductor will drop. This voltage drop counteracts the voltage of the source and therefore reduces the net voltage across system load 112 at the system voltage output, V_{SYSTEM}. Over time, the current through the inductor will increase slowly as the voltage drop across the inductor decreases, thereby increasing the net voltage seen by system load 112. During this time, the inductor is storing energy in the form of a magnetic field.

If the switch (HS1 or HS2) is opened before the inductor (L1 or L2) has fully charged (i.e., before it has allowed all of the current to pass through by reducing its own voltage drop to 0), then there will always be a voltage drop across it, so the net voltage seen by system load 112 will always be less than the input voltage source. In this way, the output voltage may be lower than the input voltage. Whenever the switch (HS1 or HS2) is opened, the voltage source is removed from the circuit and the current will slowly drop. Again, the current through the inductor (L1 or L2) does not change instantly. Accordingly, the voltage across the inductor (L1 or L2 will be reversed and the inductor (L1 or L2 will act as a voltage source. In the illustrated example, a current flows to the battery and system load 112 from an input voltage source through v_chg and one or more of HS1 and HS2. To maintain this current when the input voltage source is removed, the inductor (L1 or L2) will take the place of the voltage source and provide the same net voltage to system load 112 and the battery. Over time, the current through the inductor (L1 or L2) will decrease gradually and accordingly, the voltage across the inductor (L1 or L2) will also decrease. During this time, the inductor (L1 or L2) is discharging its stored energy (stored in the form of a magnetic field) into the rest of the circuit. As discussed above, when the switch (HS1 or HS2) is opened corresponding switch (LS1 or LS2) may be closed.

If the switch (HS1 or HS2) is closed again before the inductor (L1 or L2) fully discharges, system load 112 and battery will be at a non-zero voltage. A capacitor, C_{OUT}, placed in parallel with system load 112 may help to filter the system voltage output, V_{SYSTEM}, as the inductor (L1 or L2) charges and discharges in each cycle. Capacitor C_{CHG} may be used to filter the charging voltage input when a USB adaptor is used as a voltage input. Conversely, capacitor C_{CHG} may be used to filter an output voltage when the USB adaptor is used as a voltage output, as described herein, i.e., when HS2/LS2 is used as a boost converter circuit. Capacitor C_{IN} may provide similar filtering to the input/charging voltage. For example, C_{IN} may provide a filtering between input voltage, v_in, and ground, v_pgnf. As discussed above, when the switch (HS1 or HS2) is closed corresponding switch (LS1 or LS2) may be opened.

Having generally described the operation of the buck converter aspects of two-phase buck converter 100, the boost converter aspects are now described. Generally, the basic operation of a boost converter may function based on the same principle of an idealized inductor, i.e., that the current through an inductor generally does not change instantaneously. In a boost converter, the output voltage is higher than the input voltage.

When a switch (LS1 or LS2 is closed, current flows through the inductor (L1 or L2) and the inductor (L1 or L2) stores energy. When the switch (LS1 or LS2) is opened, current will be reduced because the voltage polarity on the inductor is reversed. In this phase, HS1 or HS2 is closed and voltage across the inductor is (Vin-Vout) which is negative in a Boost converter. In the on-state, the voltage is simply Vin. The inductor (L1 or L2) will oppose a change or a reduction in current through the inductor (L1 or L2). Accordingly, the polarity across the inductor (L1 or L2) will be reversed. As a result, two sources, for example, the battery and inductor (L1 or L2), will be in series causing a higher voltage to charge capacitor C_{CHG} through the diode in for example, HS1 or HS2.

If the switch (LS1 or LS2) is cycled fast enough, the inductor (L1 or L2) will not discharge fully in between charging stages, and system load 112 will always see a voltage greater than that of the input source alone when the switch is opened. (“Fast enough” will depend on the particular resistances, inductances, and capacitances of the circuitry involved.) Typical switching frequencies in some examples of these applications may be 1-3 MHz, however other frequencies are possible and will generally depend on the components used, for example, inductors L1 and L2. In addition, while the switch (LS1 or LS2) is opened, the capacitor C_{CHG} in parallel with the load on a USB adaptor is charged to this combined voltage. When the switch (LS1 or LS2) is then closed, capacitor C_{CHG} provides the voltage and energy to the USB adaptor. During this time, the diode in HS1 or HS2 acts as a blocking diode preventing the capacitor C_{CHG} from discharging through the switch (LS1 or LS2). The switch (LS1 or LS2) may be opened again to prevent capacitor C_{CHG} from discharging enough that the voltage across the capacitor C_{CHG} drops more than some predetermined acceptable level, for example, within the voltage tolerance of an electronic device connected to the USB adaptor.

In operation, a boost converter may operate in two states. The first state is an on-state wherein the switch (LS1 or LS2) is closed resulting in an increase in the inductor (L1 or L2) current. The second state is an off-state wherein the switch (LS1 or LS2) is open and the only paths offered to inductor (L1 or L2) current are through the diode in HS1 or HS2 or through the switches themselves, HS1 or HS2 to the capacitor C C_{CHG} and a load, for example, a device attached to the USB adaptor. This results in transferring the energy accumulated during the on-state into the capacitor. The current from, for example, the battery is the same as the inductor current such that the current is not discontinuous through the inductor L1 or L2.

Controller 114 may be configured to control switches HS1, HS2, HS3, LS1, and LS2 through HS drivers and LS drivers to implement the functionality described herein. For example, controller 114 may control a switch (for example, HS1 or HS2) such that the switch (for example, HS1 or HS2) opens and closes as needed to implement a buck mode. The corresponding switch (LS1 or LS2) may close and open as switch (HS1 or HS2) opens and closes. Additionally, controller 114 may control the duty cycle of the switches (HS1/LS1 or HS2/LS2) to control the voltage, V_{SYSTEM} . When switch (HS1 or HS2) is closed, it makes a connection between v_chg and v_sw1 or v_sw2. Generally, the longer the switch (HS1 or HS2) is closed, the higher the voltage at V_{SYSTEM} may be. This may vary depending on the current needed by, for example, system load 112, however. In some examples, the first phase and the second phase may be phase shifted 180°, however, other example phase shifts are possible, for example, 0°, 90°, or any other phase shift. In an example using three phases, the phases may be shifted 120°. In an example using four phases, the phases may be shifted 90°. In an example using eight phases, the phases may be shifted 45°. Again, however, other phase shifts are possible.

In some examples, when the switch (HS1 or HS2) is open switch (LS1 or LS2) may be closed. It will be understood that switches HS1 and HS2 may be independently controllable. In some examples, HS1 may be open when HS2 is closed and HS1 may be closed when HS2 is open. Switches LS1 and LS2 may also be independently controllable. Similarly, in some examples, LS1 may be open when LS2 is closed and LS1 may be closed when LS2 is open. In buck converter operation of the first phase, the control of HS1 may be tied to LS1 so that when HS1 is open, LS1 is closed, and when HS1 is closed, LS1 is open. In buck converter operation of the second phase, the control of HS2 may be tied to LS2 so that when HS2 is open, LS2 is closed, and when HS2 is closed, LS2 is open.

Controller 114 may also open and close switches LS1 or LS2 to implement a boost mode as described herein. Controller 114 may also control HS1 and HS2 to implement a boost mode as described herein. The controller may be configured to allow one phase to act as a boost converter while another phase acts as a buck converter. Alternatively, both phases may act as buck converters or both phases may act as boost converters. Additionally, while two phases are illustrated in FIG. 1, in some examples, more than two phases may be implemented. For example, another circuit might include four phases. In such an example, the phases might be shifted 90°; however, again, other phase shifts are possible. Two-phase buck converter 100 may be configured for low power charging by using only a single phase to charge the battery. For example, a single phase may be used to provide a trickle charging mode.

In the illustrated example of FIG. 1, a portion of the circuitry may be provided in a single chip 110. Such a chip 110 may include transistors HS1, HS2, HS3, LS1, and LS2, which may act as switches and may be controlled by controller 114, which in some examples, may be internal to chip 110. Chip 110 may include a wireless input, v_wireless, which may be used to implement wireless charging functionality, as described herein. Chip 110 may include also include a charging voltage input, v_chg, which may be used to implement an alternative charging functionality, such as using a USB adaptor or other connector as described herein. Voltage in, v_in, may be used in conjunction with a ground input, v_pgnd, such that an input capacitor, C_{IN}, may be used to filter the charging voltage. The system voltage, v_sys, may be used to provide an input voltage into chip 110. Two outputs, v_sw1 and v_{'}sw2, are illustrated in the buck converter of chip 110. Note that one or more of these outputs v_sw1 and v_sw2 may be used as switching nodes of the Boost converter to one or more boost converters that may be implemented using chip 110.

While FIG. 1 illustrates the use of two inductors L1 and L2, other filtering circuitry might be used, such as for example, filtering circuitry using inductors, capacitors, or other filtering components. Additionally, in some examples, switches HS1, HS2, LS1, and LS2 may be transistors. In other examples, switches HS1 and HS2 may be transistors, while switches LS1 and LS2 may be diodes.

As illustrated in FIG. 1, a two-phase buck converter 100 includes a first low-side switch LS1 and a first high-side switch HS1 defining a first phase. The two-phase buck converter 100 further includes a second low-side switch LS2 and a second high-side switch HS2 defining a second phase. Controller 114 may be configured to open and close at least one of the first low-side switch LS1, the first high-side switch HS1, the second low-side switch LS2, and the second high-side switch HS2 to implement a buck mode. In the example illustrated in FIG. 1, controller 114 may be further configured to open and close at least one of the first low-side switch LS1, the first high-side switch HS1, the second low-side switch LS2, and the second high-side switch HS2 to implement a boost mode. Controller 114 may be further configured to control the duty cycle of at least one switch in at least one of the first phase and the second phase to implement at least one of a trickle charge, a constant current, or a constant voltage. A first filter element L1 may be coupled to an output of the first phase and a second filter element may be coupled to an output of the second phase. In some examples, the first filter element and the second filter element may be inductors.

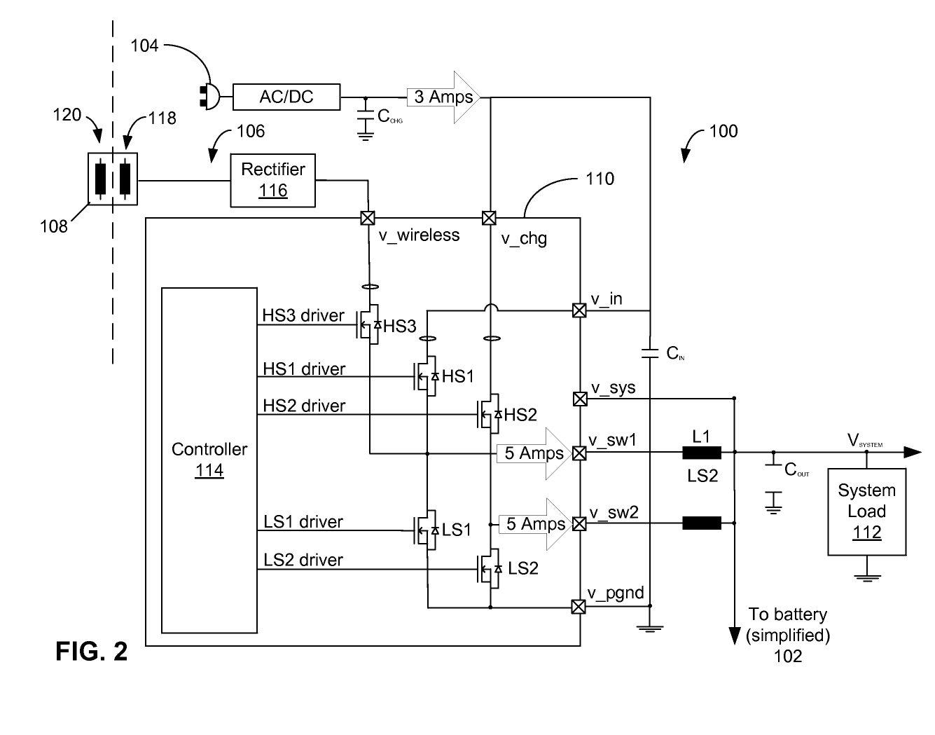

FIG. 2 is a block diagram illustrating the two-phase buck converter 100 of FIG. 1 configured in a “fast” charging mode. In the example of FIG. 2, both phases may be used to provide a high current for fast charging. In this example, a 10 A output is provided, 5 A through v_sw1 and 5 A through v_sw2. The duty cycle of each phase may be used to set the conversion ratio of the two-phase buck converter 100, i.e. the output to input voltage ratio. In an ideal buck converter, the duty cycle would be completely independent of the value of the current. Due to parasitic resistive components, however, with a higher current the duty cycle may be increased to compensate the losses and may generally be higher to provide the high current. An input of 3 A at 12 volts is provided. Note that it is generally power, rather than current that is conserved. Thirty-six watts of power is provided as an input, 12 volts times 3 A, 12v×3 A=36 W. Assuming an ideal, 100% efficient buck converter, the voltage output for 10 A would be 3.6V, 36 W divided by 10 A, 36 W/10 A=3.6 volts. A more typical efficiency may be 95%. Accordingly, the voltage may be 5% lower, or approximately 3.42 volts.

As discussed above, the buck converter controls the current through an inductor by using two switches (for example, transistors). Initially, in an example both switches may be open so that no charging occurs, i.e., no or very low current flows. When one switch, for example, HS1 is first closed, the current will begin to increase through inductor L1. While HS1 is closed, HS2 may be open. When HS1 is subsequently opened, HS2 may be closed and the current will begin to increase through inductor L2. Since current through an inductor (L1 and L2) cannot increase instantly, the voltage across the inductor will drop. This voltage drop counteracts the voltage of the source and therefore reduces the net voltage across system load 112, V_{SYSTEM}. Over time, the current through the inductor (L1 or L2) will increase as the voltage drop across the inductor decreases, thereby increasing the net voltage seen by system load 112. During this time, the inductor is storing energy in the form of a magnetic field.

Switches HS1 and HS2 may be opened before the corresponding inductors L1 and L2 have fully charged then there will always be a voltage drop across them, so the net voltage seen by system load 112 will always be less than the input voltage source (when switches HS1 and HS2 are opened before the corresponding inductors L1 and L2 have fully charged). In this way, the output voltage may be lower than the input voltage.

Since switches (HS1 or HS2) may be opened and closed alternatively to each other the voltage source is generally not removed from the circuit. Accordingly, current continues to be provided to system load 112, the battery, and C_{OUT}. The current in each phase may generally change as described above with respect to FIG. 1.

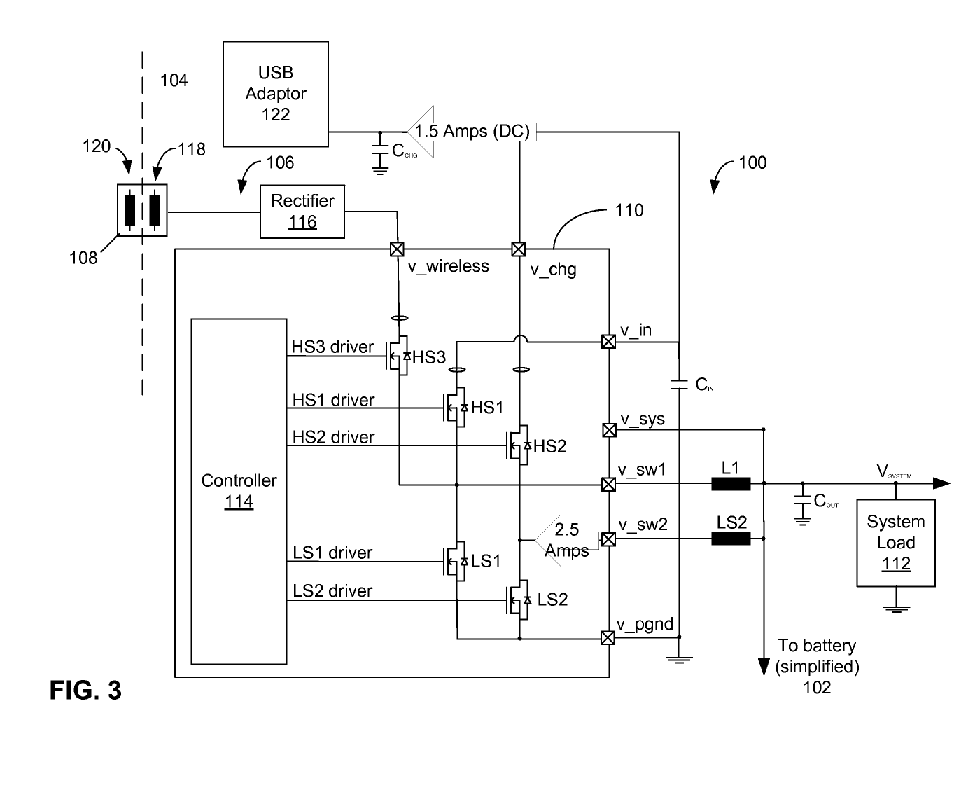

FIG. 3 is a block diagram illustrating the two-phase buck converter 100 of FIG. 1 configured in a boost mode. In the example of FIG. 3, boost mode is used to provide Universal Serial Bus (USB) adaptor 122 with power, which may be provided to an electronic device plugged into USB adaptor 122. For example, a boost converter of the two-phase buck converter 100 provided is coupled to a USB connector such that the boost converter provides power to the USB connector. It will be understood that, while the instant application discusses USB adaptor 122, other types of connectors may be used in other examples.

When switch LS2 is closed, current flows through the inductor L2 and the inductor L2 stores energy. When the switch LS2 is opened, current will be reduced as the impedance is higher. Accordingly, the inductor L2 will oppose a change or a reduction in current through the inductor L2. The polarity across the inductor L2 will be reversed. As a result, two sources, for example, the battery and inductor L2, will be in series causing a higher voltage to charge capacitor C_{CHG} through the diode in HS2.

If the switch LS2 is cycled fast enough, the inductor L2 will not discharge fully in between charging stages, and system load 112 will always see a voltage greater than that of the input source alone when the switch is opened. Again, “fast enough” will depend on the particular resistances, inductances, and capacitances of the circuitry involved, but in some examples may be 0.5 μs to 2 μs or other switching speeds as described herein. In addition, while the switch LS2 is opened, the capacitor C_{CHG} in parallel with the load on USB adaptor 122 is charged to this combined voltage. When the switch LS2 is then closed, capacitor C_{CHG} provides the voltage and energy to USB adaptor 122. During this time, the diode in HS2 acts as a blocking diode to prevent the capacitor C_{CHG} from discharging through the switch LS2. The switch LS2 may be opened again to prevent capacitor C_{CHG} from discharging such that the voltage across the capacitor C_{CHG} drops more than some predetermined acceptable level, for example, within the voltage tolerance of an electronic device connected to USB adaptor 122.

As illustrated in FIG. 3, some circuitry from the second phase may operate in boost mode. In some examples, the first phase may operate in buck mode while the second phase is operating in boost mode. For example, wireless charging may occur on the first phase while the second phase operates in boost mode. In other examples, however, the first phase may also in boost mode. In such an example, v_wireless might not be connected to a rectifier 116 and transformer 108. A direct current power connection might be provided instead, for example.

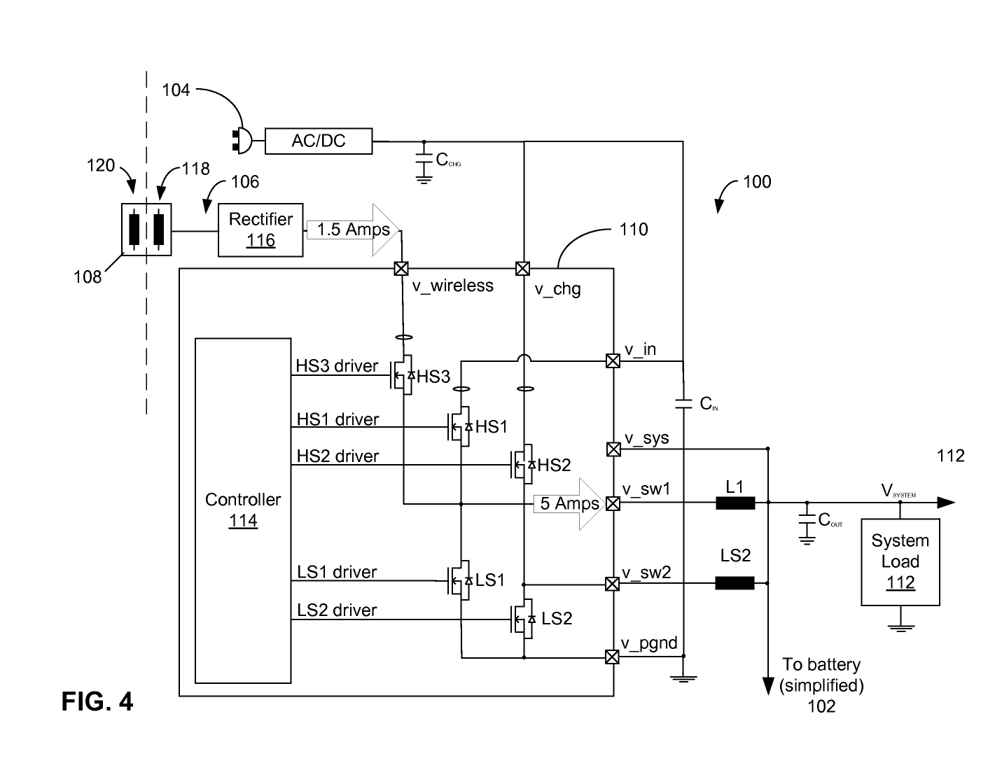

FIG. 4 is a block diagram illustrating the two-phase buck converter 100 of FIG. 1 configured in a wireless charging mode. As illustrated in FIG. 4, 1.5 A may flow through rectifier 116 and 5 A (at a lower voltage) may flow out of v_sw1 as a charging current.

Wireless charging may be implemented by inputting power through a transformer 108. As discussed above, one coil 120 of transformer 108 may be separate from two-phase buck converter 100, and another coil 118 may be part of two-phase buck converter 100. Power from transformer 108 may flow through rectifier 116, which may convert a generally alternating current signal to a generally direct current signal, which may be input into buck converter circuitry, for example, the first phase, of two-phase buck converter 100 through switch HS3. In the buck converter (phase 1) switch HS1 may begin open. The current flowing from v_chg through switch HS1 is 0. In other words, since switch HS1 is not closed, no charging voltage flows through it.

When switch HS1 is first closed, the current will begin to increase through inductor L1. Since current through inductor L1 cannot increase instantly, the voltage across the inductor L1 will drop. This voltage drop counteracts the voltage of the source and therefore reduces the net voltage across system load 112, battery, etc. Over time, the current through inductor L1 will increase as the voltage drop across the inductor decreases, thereby increasing the net voltage seen by system load 112. During this time, the inductor L1 is storing energy in the form of a magnetic field.

If switch HS1 is opened before inductor L1 has fully charged (i.e., before it has allowed a higher current to pass through by reducing its own voltage drop to 0), then there will always be a voltage drop across it, so the net voltage seen by system load 112 will always be less than the input voltage source. In this way, the output voltage may be lower than the input voltage. Whenever switch HS1 is opened, the voltage source is removed from the circuit and the current will slowly drop. Again, the current through inductor L1 does not change instantly. Accordingly, the voltage across inductor L1 will be reversed and inductor L1 will act as a voltage source. In the illustrated example, a current flows to the battery and system load 112 from an input voltage source through v_chg and HS1. To maintain this current when the input voltage source is removed, inductor L1 will take the place of the voltage source and provide the same net voltage to system load 112 and the battery. Over time, the current through inductor L1 will decrease and accordingly, the voltage across inductor L1 will also decrease. During this time, inductor L1 is discharging its stored energy (stored in the form of a magnetic field) into the rest of the circuit.

If switch HS1 is closed again before inductor L1 fully discharges, system load 112 and battery will be at a non-zero voltage. A capacitor, C_{OUT}, placed in parallel with system load 112 may help to filter the voltage as inductor L1 charges and discharges in each cycle. Capacitor C_{CHG} may be used to filter the charging voltage input when USB adaptor 122 is used as a voltage input.

In the illustrated example, wireless charging uses switched mode charging. In other examples, the wireless charging switch may be connected to a linear charger instead. For example, separate linear charging circuitry might be coupled to the battery and/or system load 112.

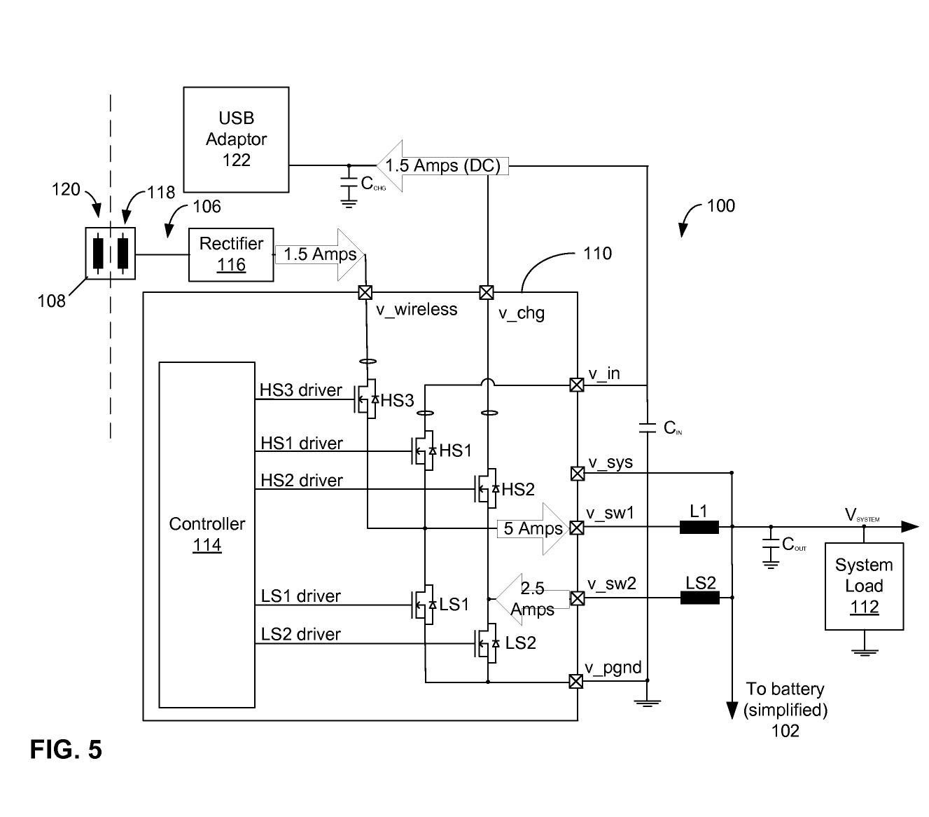

FIG. 5 is a block diagram illustrating the two-phase buck converter 100 of FIG. 1 configured in both a boost mode and a wireless charging (buck) mode. As illustrated in FIG. 5, 1.5 A may flow through rectifier 116 and 5 A (at a lower voltage) may flow out of v_sw1 as a charging current, with the first phase circuitry (HS1/LS1) functioning in a buck converter mode. As illustrated in FIG. 5, the second phase circuitry (HS2/LS2) may be configured to operate in a boost mode as also illustrated in the example of FIG. 3. Again, boost mode may be used to provide USB adaptor 122 with power, which may be provided to an electronic device plugged into the USB adaptor 122. It will be understood that, while the instant application discusses USB adaptor 122, other types of connectors may be used in other examples.

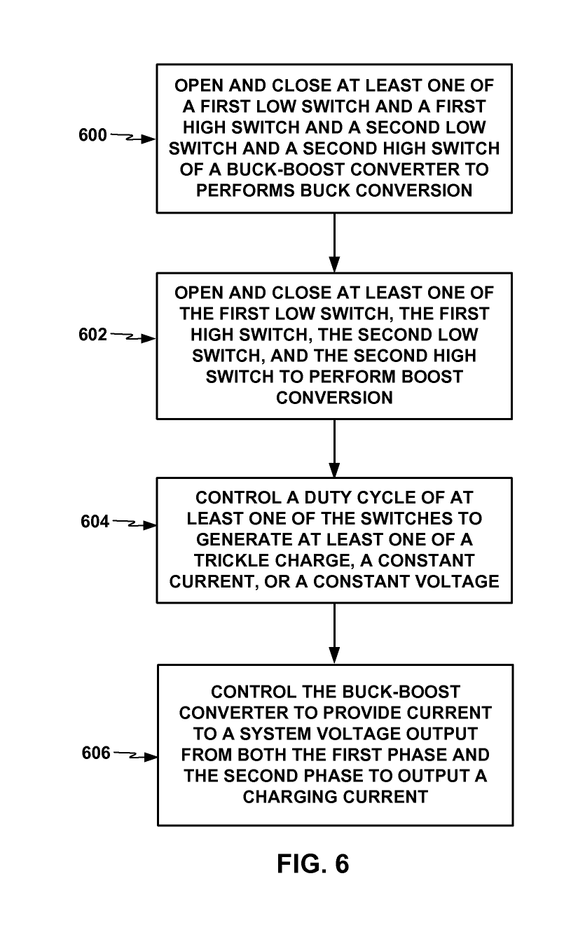

FIG. 6 is a flowchart illustrating a method for a buck converter charger in a multiphase buck converter topology. In implementing the method a two-phase buck converter 100 may include a first low-side switch LS1 and a first high-side switch HS1 and a second low-side switch LS1 and a second high-side switch HS2 and a controller 114. In some examples, HS1, HS2, LS1, and LS2 may be transistors. The transistors may include BJTs, JFETs, IGFETs (MOSFETs), IGBTs, or other types of transistors. In other examples, HS1 and HS2 may be transistors and LS1 and LS2 may be diodes. HS1, HS2, LS1, and LS2 may be other types of switches in other examples. The transistors and/or diodes may comprise silicon, germanium, gallium arsenide, gallium nitride, silicon carbide, or another suitable material or combination of materials.

In the example of FIG. 6, controller 114 may open and close at least one of a first low-side switch LS1 and a first high-side switch HS1 defining a first phase of a two-phase buck converter 100, and a second low-side switch LS2 and a second high-side switch HS2 defining a second phase of the two-phase buck converter 100 such that the two-phase buck converter 100 performs buck conversion of a signal (600).

Controller 114 may open and close at least one of the first low-side switch LS1, the first high-side switch HS1, the second low-side switch LS1, and the second high-side switch HS1 of the two-phase buck converter 100 such that the two-phase buck converter 100 performs boost conversion of a signal (602). In an example, power from a battery may be used to provide power to the boost converter. Power may also be provided by a set of switches, for example, LS1/HS1 or LS2/HS2. In other words, a phase operating as a buck converter may provide power to the boost converter. For example, one set of switches LS1/HS1, LS2/HS2 of two-phase buck converter 100 may be connected to a charging source and provide energy to one or more switches LS1, HS1, LS2, HS2 that may perform boost conversion. Note that while switches may operate in sets LS1/HS1, LS2/HS2 to perform buck conversion, this is not necessarily required.

Controller 114 may control a duty cycle of at least one of the switches LS1, HS1, LS2, or HS2 in at least one of the first phase and the second phase to generate at least one of a trickle charge, a constant current, or a constant voltage (604). For example, a single phase, for example, LS1/HS1 or LS2/HS2 may be used to provide a trickle charging mode. In such an example, controller 114 may open and close the switches LS1/HS1 or LS2/HS2 in only a single phase since only a low current is needed. Additionally, a low duty cycle may be used, since only a low current is needed. In some examples, current output may be monitored and a duty cycle of at least one of the switches LS1, HS1, LS2, or HS2 in at least one of the first phase and the second phase may provide constant current. For example, as a load on the circuit changes current for a given output voltage may vary slightly. Accordingly, the duty cycle may be modified to increase or decrease voltage to keep the current approximately constant. For example, the circuits described herein may be used to charge a battery. As the battery is charged, the internal battery voltage may increase. The current into the battery may be the difference between the charge voltage and the internal battery voltage divided by the resistance of the battery. Accordingly, the current may decrease as the internal battery voltage increases. For a constant current charge, however, controller 114 may generally increase duty cycle to keep the current constant.

Similarly, in some examples, voltage output may be monitored and a duty cycle of at least one of the switches LS1, HS1, LS2, or HS2 in at least one of the first phase and the second phase may be controlled to provide constant voltage. For example, as current output increases, voltage may begin to drop. Accordingly, the duty cycle may be increased to compensate and keep the voltage approximately constant.

Controller 114 may control the two-phase buck converter 100 to provide current to a system voltage output from both the first phase and the second phase to output a charging current (606). This current may charge one or more batteries or battery cells. The current may provide power to a load. In some examples, the current may provide power to a boost converter, as described herein.

In some examples, the two-phase buck converter 100 provided may include an alternative charging switch HS3 in the two-phase buck converter 100. The alternative charging switch HS3 may be coupled to HS1/LS1 between the first high-side switch HS1 and the first low-side switch LS1. The controller 114 may be further configured to control the alternative charging switch HS3 to enable and disable an alternative charging source. A coil 118 (part of transformer 108) and a rectifier 116 may be coupled to the alternative charging switch and configured to provide power from the coil 118, through the rectifier 116 to the alternative charging switch. In some examples, alternative charging switch HS3 may be coupled to a linear regulator to provide not just an alternative charging source, but an alternative method of charging, i.e. linear regulator rather than a switching mode converter.

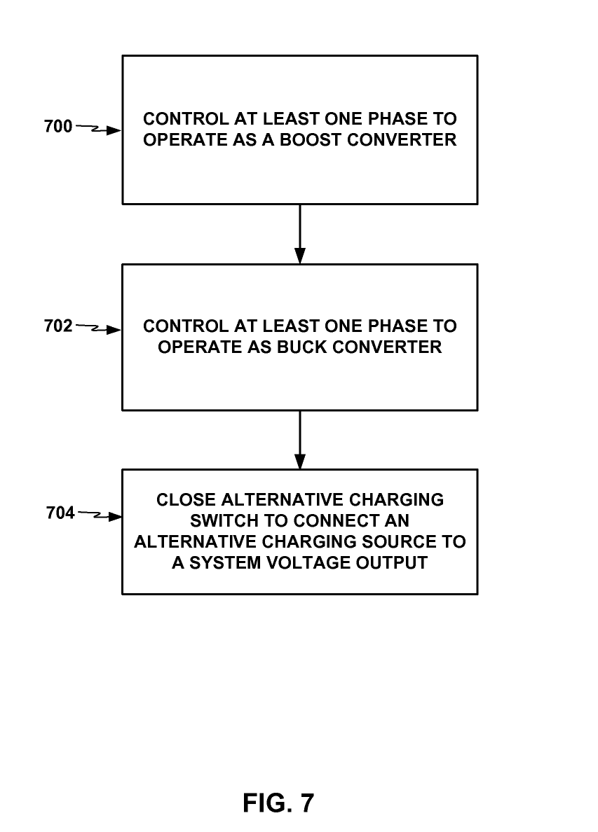

FIG. 7 is another flowchart illustrating another method for a buck converter charger in a multiphase buck converter topology. In one example, a multiphase buck converter topology may include at least a first phase, a second phase, and an alternative charging switch. The first phase includes a first high-side switch HS1 and a first low-side switch LS1 and the second phase includes a second high-side switch HS2 and a second low-side switch HS2.

In the illustrated example of FIG. 7, controller 114 controls at least one phase to operate as a boost converter (700). The boost converter may operate in two states. The first state is an on-state wherein the switch (LS1 or LS2) is closed resulting in an increase in the inductor (L1 or L2) current. The second state is an off-state wherein the switch (LS1 or LS2) is open and the only paths offered to inductor (L1 or L2) current are through the diode in HS1 or HS2 or through the switches themselves, HS1 or HS2 to the capacitor C C_{CHG} and a load, for example, a device attached to the USB adaptor. This results in transferring the energy accumulated during the on-state into the capacitor. The current from, for example, the battery is the same as the inductor current such that the current is not discontinuous through the inductor L1 or L2.

Controller 114 controls at least one phase to operate as buck converter (702). For example, controller 114 may control a switch (for example, HS1 or HS2) such that the switch (for example, HS1 or HS2) opens and closes as needed to implement a buck mode. The corresponding switch (LS1 or LS2) may close and open as switch (HS1 or HS2) opens and closes. Additionally, controller 114 may control the duty cycle of the switches (HS1/LS1 or HS2/LS2) to control the voltage, V_{SYSTEM}. When switch (HS1 or HS2) is closed, it makes a connection between v_chg and v_sw1 or v_sw2. Generally, the longer the switch (HS1 or HS2) is closed, the higher the voltage at V_{SYSTEM} may be. This may vary depending on the current needed by, for example, system load 112, however. In some examples, the first phase and the second phase may be phase shifted 180°, however, other example phase shifts are possible, for example, 0°, 90°, or any other phase shift. In an example using three phases, the phases may be shifted 120°. In an example using four phases, the phases may be shifted 90°. In an example using eight phases, the phases may be shifted 45°. Again, however, other phase shifts are possible.

In some examples, when the switch (HS1 or HS2) is open switch (LS1 or LS2) may be closed. It will be understood that switches HS1 and HS2 may be independently controllable. In some examples, HS1 may be open when HS2 is closed and HS1 may be closed when HS2 is open. Switches LS1 and LS2 may also be independently controllable. Similarly, in some examples, LS1 may be open when LS2 is closed and LS1 may be closed when LS2 is open. In buck converter operation of the first phase, the control of HS1 may be tied to LS1 so that when HS1 is open, LS1 is closed, and when HS1 is closed, LS1 is open. In buck converter operation of the second phase, the control of HS2 may be tied to LS2 so that when HS2 is open, LS2 is closed, and when HS2 is closed, LS2 is open.

Controller 114 closes the alternative charging switch in the multiphase buck converter topology to connect an alternative charging source to a system voltage output, the alternative charging switch coupled to the first phase between the first high-side switch and the first low-side switch (704).

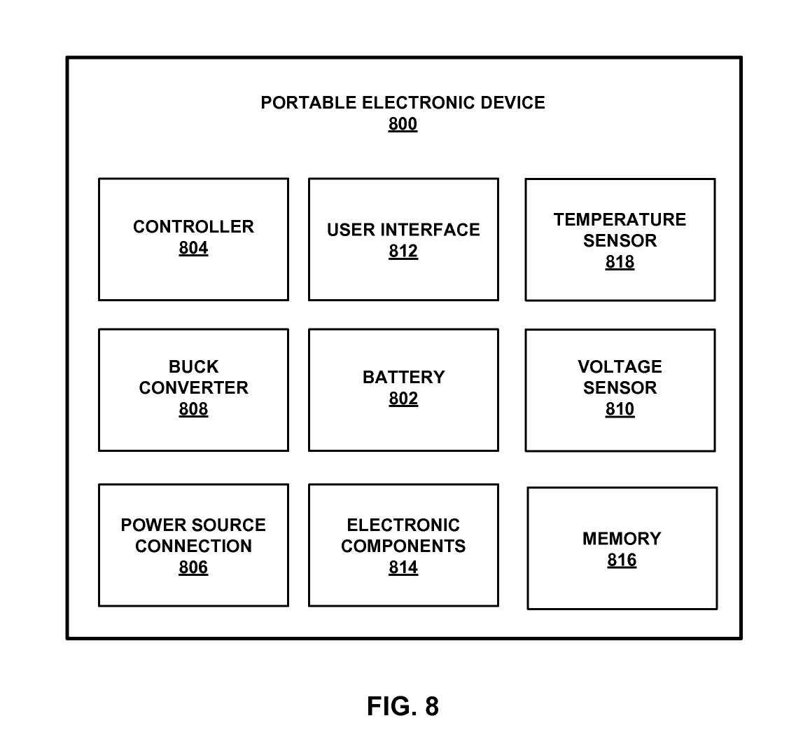

FIG. 8 illustrates portable electronic device 800. In different examples, portable electronic device may represent a personal digital assistant (PDA), laptop computer, tablet computer, e-book reader, digital camera, digital recording device, digital media player, video gaming device, mobile telephone handset, cellular or satellite radio telephone, such as a smart phone, or other portable electronic device. Portable electronic device 800 includes battery 802, which includes at least one electrochemical battery cell. Portable electronic device 800 further includes controller 804, which is configured evaluate a charge state of battery 802 while charging battery 802 from an external power source connected to portable electronic device 800 via power source connection 806. In some examples, controller 804 may be a multipurpose processor configured to execute instructions stored in memory 816, a non-transitory computer readable medium.

More specifically, controller 804 is configured to deliver, from power source connection 806, a substantially constant current to charge battery 802. For example, controller 804 may issue instructions to buck converter 808, which is configured to receive power from an external power source via power source connection 806, to deliver a substantially constant current to charge battery 802. Controller 804 may issue instructions to buck converter 808 deliver the substantially constant current for a period of time sufficient to settle the bias electromotive force applied according to the charging voltage and measuring the battery voltage during the constant current charging, such as a period of time sufficient to cause battery 802 voltage to be substantially dependent on only the substantially constant current, the state of charge of battery 802, and a battery temperature. In some examples, buck converter 808 may be the same or substantially similar to two-phase buck converter 100.

Controller 804 is further configured to measure a charging voltage of battery 802 via voltage sensor 810 during or immediate subsequent to the application of the substantially constant current to charge battery 802. Controller 804 is further configured to evaluate a state of charge of battery 802 based on the measured charging voltage, and, optionally, a measured battery temperature, as indicated by temperature sensor 818. In some examples, controller 804 may use a look-up table to correlate the measured charging voltage, and optionally, battery temperature, to a state of charge of battery 802. The data in the look-up table may come from testing of battery 802 or another battery of substantially similar construction. Theoretically, the correlation between the measured charging voltage to a state of charge of battery 802 is represented by Equation 1 below. In some examples, Equation 1 may be used instead of a look-up table to correlate the measured charging voltage to a state of charge of battery 802.

R(cell)=v(battery_{I1})/I1 (Equation 1)

With respect to Equation 1, above, R (cell) represents the state of charge of battery 802, I1 represents the substantially constant current applied to charge battery 802, V(battery_{I1}) represents the measured charging voltage of the battery, and V (cell) represents the actual voltage of battery 802 absent the substantially constant current. Equation 1 may be derived as follows:
(1) By ohm's law V=IR;
with respect to a battery cell R=LEN/Alpha*(I/AREA),
wherein Alpha is conductivity of a material,
wherein LEN is length where V is applied, in a battery, the distance between the cathode and anode, and
wherein AREA is the cross-sectional area of current flow between cathode and anode.
(2) I1/AREA=Alpha1*V1/LEN
→J1=Alpha1*E1;
J1 is current density (I1/Area) and E1=Electric field (V1/LEN). Alpha1 is the conductivity under this condition.
(3) Alpha1=n1*q*v/E1=n*q*u1; where u1 is mobility of electron, v/E1; and
n is the available +ion and −ion for combination and separation.; q defines the charge of electrons.
(4) The applied voltage and current are constant over a period of time gives raise that the total electron and mobility are at equivalent. Thus the R(cell) represent the state of charge at equivalent as I1 and V1 are function related to (n1,q, u1).

Note that Equation 1 and a corresponding look-up table only provides for a precise correlation following the application of constant current charging to battery 802 for a period sufficient to settle the bias electromotive force applied according to the charging voltage, as Equation 1 assumes the bias electromotive force is settled. Controller 804 and buck converter 808 facilitate the application of this constant current charging of the battery for such a sufficient period by separately directing a power from the external power source via power source connection 806 to satisfy varying power loads of the components of portable electronic device 800, including controller 804 itself, user interface 812, other electronic components 814. In some examples, electronic components 814 may include global positioning system (GPS) receiver, telecommunications module, such as a cellular, Wi-Fi and/or Bluetooth module, one or more processors and/or other circuitry of portable electronic device 800. In contrast to portable electronic device 800, in other portable electronic devices, the current supplied to charge a battery may vary according to the load demands of electronic components of the portable electronic devices. Varying the current supplied to the battery may preclude the use of a look-up table to correlate the measured charging voltage to a state of charge of battery as the measured current of the battery during charging would be expected to be a function of varying current applied over time, resulting in a bias electromotive force that would be difficult to account for.

In some examples, controller 804 may further be configured to take a second voltage measurement with voltage sensor 810 that may allow more precise evaluation of the state of charge of battery 802. For example, controller may, after delivering the substantially constant current to charge battery 802, momentarily deliver a test current to battery 802, and measure a test voltage of battery 802 with voltage sensor while delivering the test current to battery 802. Evaluation of the state of charge of battery 802 may be based on the measured charging voltage, and the measured test voltage, as well as, optionally a measured temperature of battery 802, as indicated by temperature sensor 818. In some examples, controller 804 may use a look-up table to correlate the measured charging voltage, test voltage and optionally, battery temperature, to a state of charge of battery 802. The data in the look-up table may come from testing of battery 802 or another battery of substantially similar construction. Theoretically, the correlation between the measured charging voltage and test voltage to a state of charge of battery 802 is represented by Equation 2 below. In some examples, Equation 2 may be used instead of a look-up table to correlate the measured charging voltage and measured test voltage to a state of charge of battery 802.

$$R 2 ( cell ) = \frac{V ( {battery}_{I 2} ) - V ( {battery}_{I 1} )}{I 2 - I 1} \qquad ( Equation 2 )$$

With respect to Equation 2, above, R2 (cell) represents state of charge of battery 802, I1 represents the substantially constant current applied to charge battery 802, I2 represents the test current applied to battery, V(battery_{I1}) represents the measured charging voltage of battery 802, and V(battery_{I2}) represents the measured test voltage of battery 802. Equation 2 may be derived as follows:
(1) From equation 1 J1=Alpha1*E1.
(2) Give a check in I1 to I2 and E1 to E2, J1 becomes J2; E1 becomes E2.
(3) J2=J1+delta_J,
wherein J1 is initial current density under E1, and delta_J is the current density changes as E1 changes to E2.
(4) J2−J1=delta_J;
wherein delta_J=delta_Alpha*(E2−E1),
wherein delta_Alpha is the conductivity changes as the electric field changes from E1 to E2.
(5) J2−J1 is proportional to 12−I1.
(6) E2−E1 is proportional to V2−V1.
(7) R2 thus is proportional to 1/delta_alpha.

At instant of voltage and current changes, the combination and separation occurs at the interface of cathode and anode before the ion from the respective material away from the interface replenishes the ion. Thus, during the change in current and voltage, when nearly fully charged, the availability of ions combination and separation nearer to the cathode and anode interface are lesser, and that the R2 (cell) is different when the battery is not fully charge or near fully charge. Thus, the R2 (cell) represents the state of charge with a preemptive nature to charge on the available charges.

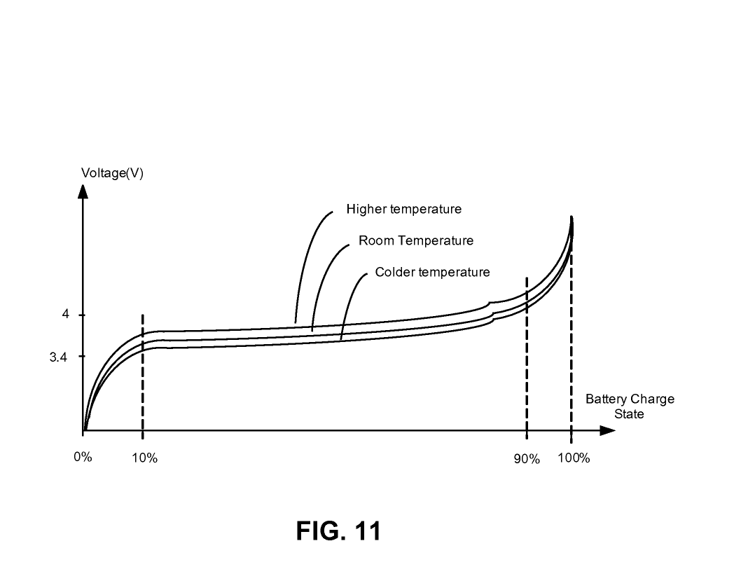

Equation 2 assumes that the electrochemistry behavior of battery 802 has not yet been substantially affected by the application of the test voltage. For this reason, controller 804 may be configured to measure the test voltage while delivering the test current to battery 802 within a very short period of time after the application of the substantially constant current. For example, controller 804 may be configured to measure the test voltage while delivering the test current to battery 802 within 100 milliseconds of delivering the substantially constant current to battery 802, within 25 millisecond of delivering the substantially constant current to battery 802, within 5 millisecond of delivering the substantially constant current to battery 802 or even within 1 millisecond of delivering the substantially constant current to battery 802. The application of a test current and a test voltage measurement with voltage sensor 810, may allow more precise evaluation of the state of charge of battery 802, particularly with battery chemistries in which the voltage measurement of the battery during constant current charging remains relatively consistent over a large portion of the possible charge states of the battery, such as a portion between a relatively low charge state, and a relatively high charge state, as illustrated in FIG. 11.

In some examples, R2 (cell) may be a set of read out data, where the data are measurements measured in successive time interval, N, of example 100 milliseconds. Value of the R2 (cell) and N value represents the state of charge of the battery. The R2 with respective N may be post-processed to find the a second minimum R2 value at one of the time interval and the R2 value and/or the N timing is represent the state of charge according to Equation 3.

dR(Cell)/dN=0 (Equation 3)
for N sample of R(cell) for post processing,
wherein dN is the sample of N at one time to the next sampling time instant,
wherein dR is the difference of the R(cell) sample over dN.

In the same or different examples, the test voltage may be applied with a rate over voltage change over time from V(battery 1) to V(battery2) instead of a step change. The test voltage may be applied by M successive time, switching between V(battery1) and V(battery2) as alternate way of current and voltage.

Under another condition, where a constant I3 current is sensed to be discharging into the system, a I4 change instant can be check for its Voltage and current ration as R3=(V4−V3)/(I4−I3) by the same sensor in the charger. Where I4 is a new current drawn, I3 is the initial steady current drawn. V4 is the voltage seen at battery for I4 changes and V3 is the voltage seen at the battery at I3. In this manner, the same principles can be applied to test a battery charge state during a constant current draw rather than a constant current charging. The voltage measurement to determine a discharge voltage is delayed until the electrochemistry of the battery has settled according the constant current discharge, the test voltage measurement occurs quickly following the application of the test current to limit the effects the test current has on the electrochemistry behavior of the battery and the resulting electromotive force on the battery.

In the case where R3 is measured, where the battery is nearly discharge, the change in R3 also increases.

Controller 804 may further be configured to store, based on the evaluation of the state of charge of battery 802, an indication of the state of charge of battery 802 in memory 816, a non-transitory computer readable medium. Controller 804 may further be configured to present, based on the evaluation of the state of charge of battery 802, a representation of the state of charge of battery 802 via user interface 812. In some examples, user interface 812 may include a display or other visual indicators.

In the same or different examples, controller 804 may further be configured to issue instructions to buck converter 808 to select between charging with the substantially constant current and charging with substantially constant voltage based on the evaluation of the state of charge of battery 802. For example, once the state of charge of battery 802 reaches a relatively high level, constant voltage charging may be preferred to constant current charging as application of constant current charging to battery 802 may degrade the capacity of battery 802 such that the storage capacity of battery 802 is reduced faster than if appropriate charging techniques are applied. Conversely, constant current charging of battery 802 is preferable below relatively high charge states of battery 802 as constant current charging of battery 802 may be faster than constant voltage charging of battery 802.

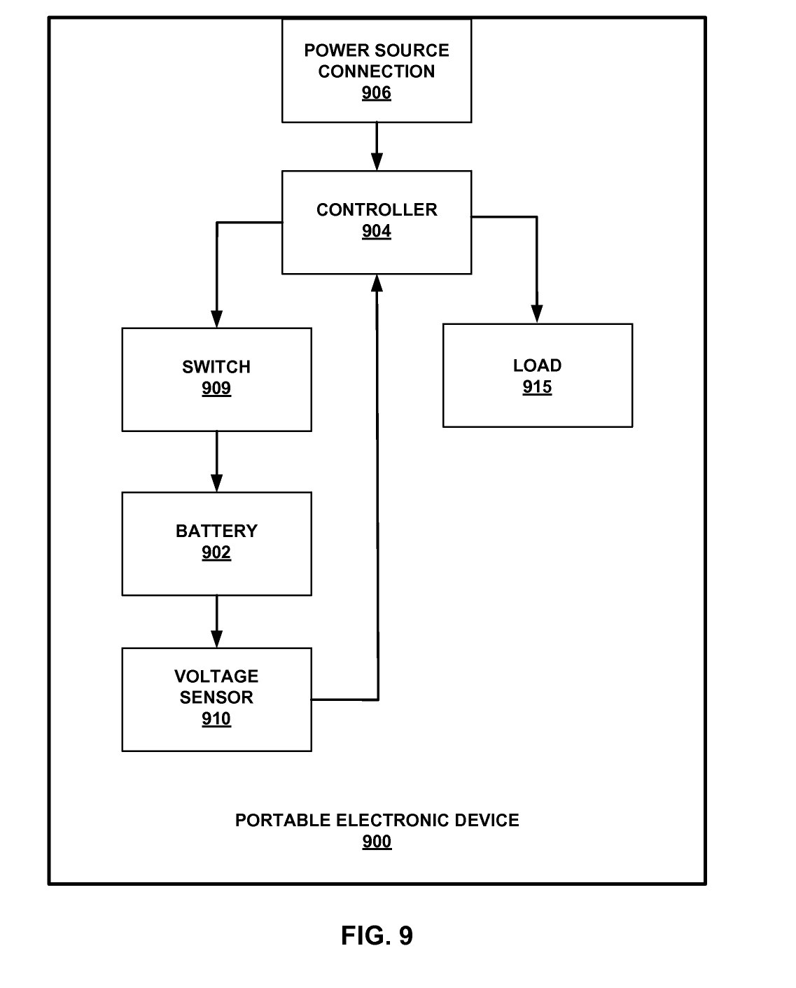

FIG. 9 is a conceptual diagram of power distribution and voltage sensing within a portable electronic device 900. Portable electronic device 900 includes power source connection 906 and controller 904. Controller 904 selectively delivers power from power source connection 906 to battery 902 and load 915. Load 915 represents power consumed by components of portable electronic device 900, such as processors, memory, wireless transmitters, displays and/or other user interfaces of portable electronic device 900. Switch 909 is configured to temporarily interrupt powers to battery 902, e.g., during an evaluation of a charge state of battery 902 while charging battery 902 from an external power source. Switch 909 may be a separate component or may simply represent the ability of controller 904 to temporarily interrupt powers to battery 902. Voltage sensor 910 is configured to take voltage measurements of battery 902 to evaluate of a charge state of battery 902 as described herein.

In some examples, portable electronic device 900 may be substantially similar to portable electronic device 800, however, as represented by controller 904 and switch 909, any circuitry that may control constant current charging or discharging of battery 902 for a period sufficient to settle the bias electromotive force applied according to the charging voltage may be used to evaluate of a charge state of battery 902 while charging battery 902 from an external power source. In this manner, the buck converters described with respect to FIGS. 1-8 are merely examples that facilitate constant current charging or discharging of a battery for a period sufficient to settle the bias electromotive force applied according to the charging voltage. As represented by controller 904, any other circuity that accomplishes the same may be used as well to evaluate of a charge state of battery 902 while charging battery 902 from an external power source.

Controller 904 evaluates a state of charge of battery 902 based on the measured charging voltage, and, optionally, the measured test voltage and/or a temperature of battery 902 (928). Controller 804 stores an indication of the state of charge of battery 902 in memory (930).

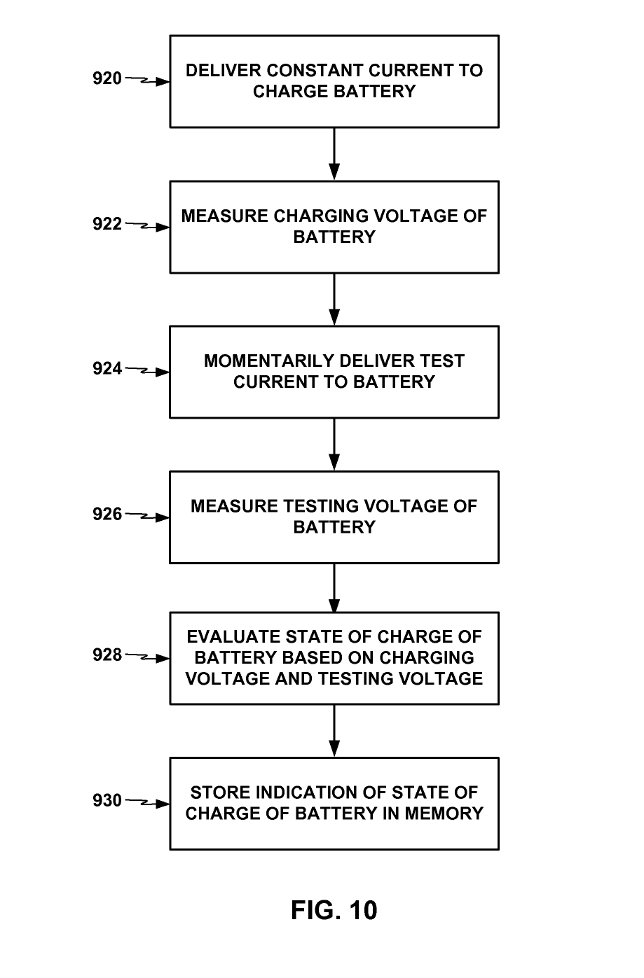

FIG. 10 is a flowchart illustrating techniques for taking battery charge state measurements coincident with constant current charging of the battery. For clarity, the techniques of FIG. 10 are described with respect to portable electronic device 900 of FIG. 9. However, the techniques of FIG. 10 are not limited to portable electronic devices, but may be applied to other devices or stand-alone battery chargers.

Controller 904 delivers a substantially constant current to charge battery 902 from power source connection 906 via switch 909 (920). For example, delivering the substantially constant current to charge battery 902 may include delivering the substantially constant current for a period of time sufficient to cause the battery voltage to be substantially dependent on only the substantially constant current, the state of charge of the battery, and a battery temperature. While delivering the substantially constant current to battery 902, controller 904 measures a charging voltage of battery 902 with voltage sensor 910 (922).

Controller 904 optionally, momentarily delivers a test current to battery 902, which may include pausing the delivery of charging voltage with switch 909, after delivering the substantially constant current to charge battery 902 (924), and measures a test voltage of battery 902 with voltage sensor 910 (926). While the voltage measurement to determine a charging voltage is delayed until the electrochemistry of the battery has settled according the constant current charging, the test voltage measurement occurs quickly following the application of the test current to limit the effects the test current has on the electrochemistry behavior of battery 902 and the resulting electromotive force on battery 802.

The techniques of FIG. 10 are distinguishable from alternative techniques in which the electrochemistry behavior of a battery is stabilized by limiting charging or discharging of current from the battery such that battery voltage measurements may be taken when a battery is in relaxation mode. For example, if a battery has a rated current, the relation mode may occur following a period of time, such as minutes, or even hours, such as between 30 minutes and 3 hours, in which the charging or discharging of current from the battery is no greater than 5% of the rated current of the battery. When current is at minimal over a period of time where the electrochemistry internal to the battery reaches equilibrium, thereby representing a relaxation mode of a battery, the voltage of the battery cells is the open-circuit voltage, which may correspond to the charge state of the battery. Conversely, internal cell resistance of a battery is an electrochemistry resistance that varies with different work conditions and with time, thus is compensating the resistance under dynamic current loading is difficult. In portable electronic devices, such as cellular phones, the batteries may be constantly charging or discharging as the devices remain in a relatively constant always-on state, with increasing numbers of background applications running, such that the battery may not enter a relaxation mode on a regular basis. While measuring current consumed over time may be used to approximate a charge state, such calculations are affected by the precision of the current measurements and errors in current measurement compound over time.

In contrast, the techniques of FIG. 10 facilitate battery chart state evaluations during charging by isolating the battery from the loading of other electronic components of a portable electronic device during charging. As portable electronic devices must be charged on a regular basis, the techniques of FIG. 10 allow for charge state evaluations independent of current measurements over time.

Accurate charge state evaluations may be useful to provide indications to a user of the remaining battery life of an electronic device. In addition, accurate charge state evaluations may be useful select appropriate charging techniques based on the charge state of a batter. For example, constant current charging of a battery may be preferable below relatively high charge states of the battery to provide relatively fast charging. However, at a relatively high charge states, constant voltage charging may be preferred to constant current charging as application of constant current charging to a battery may degrade the capacity of the battery.

FIG. 11 is a plot of voltage versus battery charge state during charging including constant current charging below relatively high charge states at various battery temperatures for an example battery. FIG. 11 specifically indicates voltage versus battery charge state at three different battery temperatures: room temperature, higher than room temperature and lower than room temperature.

As indicated in FIG. 11, at relatively low battery charge states, in this example, battery charge states of about 10% or less, voltage of the battery is highly dependent on the battery charge state. In this range, because the voltage of the battery is so dependent on the battery charge state, a voltage measurement may facilitate a reasonably accurate evaluation of the battery charge state even if the electromotive force applied to the battery is not settled, for example, due to changing current charging or draw on the battery. For this reason, evaluation of the battery charge state at relatively low battery charge states may be reasonably accurate not withstanding dynamic loading or discharge of the battery.

Similarly, at relatively high battery charge states, in this example, battery charge states of about 90% or more, voltage of the battery is also highly dependent on the battery charge state. In this range, because the voltage of the battery is so dependent on the battery charge state, a voltage measurement may facilitate a reasonably accurate evaluation of the battery charge state even if the electromotive force applied to the battery is not settled, for example, due to changing current charging or draw. For this reason, evaluation of the battery charge state at relatively high battery charge states may also be reasonably accurate not withstanding dynamic loading or discharge of the battery.

In contrast, at midrange battery charge states, in this example, battery charge states of between 10% and 90%, voltage of the battery is relatively flat across this range of battery charge states for a given battery temperature. Within the midrange battery charge states, the techniques of FIG. 10, including settling the basis electromotive force applied to the battery by applying a constant current charging, may facilitate accurate battery charge state evaluations. Alternatively, as described above, a voltage measurement of a battery in a relation mode may be used to facilitate battery charge state evaluations within the midrange battery charge states. However, as also described above, batteries within portable electronic devices may not enter a relaxation mode on a regular basis, which can make accurate charge state evaluation difficult or impossible without the techniques disclosed herein, including the techniques for applying constant current charging as well as the techniques for correlating battery charge state to a measured voltage during constant current charging.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

What is claimed is:

1. A method comprising:
delivering a substantially constant current to charge a battery including at least one electrochemical battery cell;
measuring a charging voltage of the battery while delivering the substantially constant current to the battery;
evaluating a state of charge of the battery based on the measured charging voltage; and
storing, based on the evaluation of the state of charge of the battery, an indication of the state of charge of the battery in a non-transitory computer readable medium.

2. The method of claim 1, further comprising:
after delivering the substantially constant current to charge the battery, momentarily delivering a test current to the battery; and
measuring a test voltage of the battery while delivering the test current to the battery,
wherein evaluating the state of charge of the battery is further based on the measured test voltage.

3. The method of claim 2, wherein the measuring the test voltage of the battery while delivering the test current to the battery comprises measuring the test voltage of the battery within 100 milliseconds of delivering the substantially constant current to the battery.

3. The method of claim 2, wherein momentarily delivering the test current to the battery comprises applying a changing voltage according to a rate over voltage change over time.

4. The method of claim 2, wherein momentarily delivering the test current to the battery comprises applying a test voltage according to a rate over voltage change over time.

5. The method of claim 2, wherein the evaluation of the state of charge of the battery based on the measured charging voltage and the measured test voltage is based on a formula including:
$$R ( cell ) = \frac{V ( {battery}_{I 2} ) - V ( {battery}_{I 1} )}{I 2 - I 1}$$
wherein R (cell) is state of charge of the battery,
wherein I1 is the substantially constant current,
wherein I2 is the test current,
wherein V(battery_{I1}) is the measured charging voltage of the battery, and
wherein V(battery_{I2}) is the measured test voltage of the battery.

6. The method of claim 2, wherein the evaluation of the state of charge of the battery based on the measured charging voltage and the measured test voltage is based on a formula over a series of N intervals including:
dR(Cell)/dN=0
wherein N is a sample of R(cell) for post processing,
wherein dN is the sample of N at one time to the next sampling time instant, and
wherein dR is the difference of the R(cell) sample over dN.

7. The method of claim 1, further comprising measuring a temperature indicating a temperature of the battery, wherein evaluating the state of charge of the battery is further based on the measured temperature.

8. The method of claim 1, further comprising selecting between charging with the substantially constant current and charging with a substantially constant voltage based on the evaluation of the state of charge of the battery.

9. The method of claim 1, further comprising delivering a varying current according to load demands of other electronic components of a portable electronic device that includes the battery while delivering the substantially constant current to charge the battery such that the load demands of the other electronic components of the portable electronic device do not substantively effect the delivery of the substantially constant current to charge the battery.

10. The method of claim 9, wherein the portable electronic device includes a buck converter charger in a multiphase buck converter topology comprising a first phase, a second phase, and an alternative charging switch, wherein the first phase includes a first high-side switch and a first low-side switch and the second phase includes a second high-side switch and a second low-side switch,
wherein the buck converter charger delivers the varying current according to load demands of other electronic components of the portable electronic device while delivering the substantially constant current to charge the battery, the method further comprising:
controlling at least one phase to operate as a boost converter;
controlling at least one phase to operate as buck converter; and
closing the alternative charging switch in the multiphase buck converter topology to connect an alternative charging source to a system voltage output, the alternative charging switch coupled to the first phase between the first high-side switch and the first low-side switch.

11. The method of claim 1, further comprising presenting, based on the evaluation of the state of charge of the battery, a representation of the state of charge of the battery via a user interface of a portable electronic device that includes the battery.

12. A portable electronic device comprising:
a battery including at least one electrochemical battery cell;
a connection to an external power source; and
a controller, wherein the controller is configured to:
deliver, from the connection to the external power source, a substantially constant current to charge the battery;
measure a charging voltage of the battery while delivering the substantially constant current to the battery;
evaluate a state of charge of the battery based on the measured charging voltage; and
store, based on the evaluation of the state of charge of the battery, an indication of the state of charge of the battery in a non-transitory computer readable medium.

13. The portable electronic device of claim 12, wherein the controller is further configured to:
after delivering the substantially constant current to charge the battery, momentarily deliver a test current to the battery; and
measure a test voltage of the battery while delivering the test current to the battery,
wherein evaluating the state of charge of the battery is further based on the measured test voltage.

14. The portable electronic device of claim 12, wherein the measuring the test voltage of the battery while delivering the test current to the battery comprises measuring the test voltage of the battery within 100 milliseconds of delivering the substantially constant current to the battery.

15. The portable electronic device of claim 11, wherein the controller is further configured to measure a temperature indicating a temperature of the battery, wherein evaluating the state of charge of the battery is further based on the measured temperature.

16. The portable electronic device of claim 11, wherein the controller is further configured to select between charging with the substantially constant current and charging with substantially constant voltage based on the evaluation of the state of charge of the battery.

17. The portable electronic device of claim 11, wherein the controller is further configured to deliver, from the connection to the external power source, a varying current according to load demands of other electronic components of a portable electronic device that includes the battery while delivering the substantially constant current to charge the battery such that the load demands of the other electronic components of the portable electronic device do not substantively effect the delivery of the substantially constant current to charge the battery.

18. The portable electronic device of claim 17, further comprising a buck converter charger in a multiphase buck converter topology comprising a first phase, a second phase, and an alternative charging switch, wherein the first phase includes a first high-side switch and a first low-side switch and the second phase includes a second high-side switch and a second low-side switch,
wherein the buck converter charger delivers the varying current according to load demands of other electronic components of the portable electronic device while delivering the substantially constant current to charge the battery based on instructions from the controller, wherein the controller is further configured to:
control at least one phase to operate as a boost converter;
control at least one phase to operate as buck converter; and
close the alternative charging switch in the multiphase buck converter topology to connect an alternative charging source to a system voltage output, the alternative charging switch coupled to the first phase between the first high-side switch and the first low-side switch.

19. The portable electronic device of claim 11, further comprising a user interface,
wherein the controller is further configured to present, based on the evaluation of the state of charge of the battery, a representation of the state of charge of the battery via the user interface.

20. A non-transitory computer readable medium storing instructions configured to cause a programmable controller to:
deliver a substantially constant current to charge a battery including at least one electrochemical battery cell;
measure a charging voltage of the battery while delivering the substantially constant current to the battery;
after delivering the substantially constant current to charge the battery, momentarily deliver a test current to the battery;
store, based on the evaluation of the state of charge of the battery, an indication of the state of charge of the battery in the non-transitory computer readable medium.
